(19) United States
(12) Patent Application Publication
(10) Pub. No.: US 2010/0102681 A1
(43) Pub. Date: Apr. 29, 2010

(54) Rotating electrical machine

(75) Inventors: Kiyotaka Koga, Nishio (JP); Yoshihisa Yamamoto, Anjo (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/585,607

(22) Filed: Sep. 18, 2009

(30) Foreign Application Priority Data
Oct. 23, 2008 (JP) 2008-273106

(51) Int. Cl. H02K 11/00

(52) U.S. Cl. 310/68 B; 903/906

(57) ABSTRACT

A rotating electrical machine includes a stator formed by disposing coils of a plurality of phases in a plurality of slots formed along an axial direction of a stator core; a rotor rotatably provided on an inner peripheral side of the stator; and a rotation position detector for detecting a rotation position of the rotor disposed on the one axial end side of the stator core.

### INCORPORATION BY REFERENCE

The disclosure of Japanese Patent Application No. 2008-273106 filed on Oct. 23, 2008 including the specification, drawings and abstract is incorporated herein by reference in its entirety.

### BACKGROUND

The present invention relates to a rotating electrical machine including a stator formed by disposing coils of a plurality of phases in slots of a stator core, and a rotor rotatably disposed on the inner peripheral side of the stator.

For example, in a stator for use in a rotating electrical machine, three-phase coils of U-phase, V-phase, and W-phase are disposed in a stator core by using jigs for holding and inserting the three-phase coils on the inner peripheral side of the stator core. After the three-phase coils are disposed in a plurality of slots of the stator core, a coil end conductor portion, which protrudes from an axial end face of the stator core, is deformed radially outward of the stator core.

In a stator manufacturing method of Japanese Patent No. 2523933, first, a coil, which has mountain-shaped front-side coil end portions that are located inside the inner diameter of a stator core, slot coil portions that are disposed in the slots, and mountain-shaped rear-side coil end portions, is formed before the coil is wound up onto the stator core. Moreover, relay coil portions, which are bent inward, are formed between the front-side coil end portions and the slot coil portions. Then, after the coil is inserted from an end face of the stator core from the relay coil portions, and insertion of the coil into the stator core is finished, the front-side coil end portions are deformed outward of the inner diameter of the core.

Thus, the coil can be formed in advance in the inserted shape into the core, and can be inserted into the stator core, whereby deformation of the coil can be prevented when the coil is inserted into the stator core.

### SUMMARY OF THE INVENTION

In Japanese Patent No. 2523933, however, the front-side coil end portions of the coil are deformed outward of the inner diameter of the core after the coil is inserted into the stator core. Thus, although the coil is not deformed when inserted into the stator core, deforming the coil after insertion into the stator core may degrade a conductor portion or an insulating coating in the deformed portion.

Moreover, if the front-side coil end portions are not deformed outward of the inner diameter of the stator core, and thus, are kept located inward of the core inner diameter, the possibility that the conductor portion or the insulating coating of the front-side coil end portions is degraded is eliminated, but the front-side coil end portions are located close to the rotor. Moreover, if a rotation position detector (e.g., a resolver) for detecting the rotation position of the rotor is disposed on the inner peripheral side of the front-side coil end portions, noise generated in the front-side coil end portions may reduce the detection accuracy of the rotation position detector. In order to solve this problem, it is possible to dispose the rotation position detector away from the front-side coil end portions. However, this increases the size of the rotating electrical machine accordingly as the rotation position detector is located away from the front-side coil end portions.

The present invention has been developed in view of the above problem of the related art, and it is an object of the present invention to provide a rotating electrical machine whose size can be reduced while being capable of accurately detecting the rotation position of a rotor.

A rotating electrical machine according to a first aspect of the present invention includes a stator formed by disposing coils of a plurality of phases in a plurality of slots formed along an axial direction of a stator core, and a rotor rotatably provided on an inner peripheral side of the stator, and is characterized in that the coils of the plurality of phases are disposed so that, in the slots of the same phase, a plurality of coil conductors of the same phase are arranged adjacent to each other in a radial direction of the stator core, in one end-side coil end portion that protrudes from one axial end face of the stator core, the plurality of coil conductors of the same phase are arranged on a radially outer peripheral side of an inner peripheral end face of the stator core, and in the other end-side coil end portion that protrudes from the other axial end face of the stator core, the plurality of coil conductors of the same phase are arranged on a radially inner peripheral side of the inner peripheral end face of the stator core. Further, the rotating electrical machine according to the first aspect is also characterized in that a rotation position detector for detecting a rotation position of the rotor is disposed on the one axial end side of the stator core.

In the rotor in the rotating electrical machine according to the first aspect of the present invention, the rotation position detector for detecting the rotation position of the rotor is disposed on the one axial end side of the stator core. In the case where the rotation position detector is disposed on the other axial end side of the rotor, the other end-side coil end portion and the rotation position detector are located close to each other. Thus, noise is superimposed on the rotation position detector, thereby reducing the detection accuracy. In this case, if the rotation position detector is disposed so as to avoid interference with the other end-side coil end portion, the axial dimension of the rotating electrical machine is increased.

On the other hand, by disposing the rotation position detector on the one axial end side of the rotor, the one end-side coil end portion and the rotation position detector can be disposed away from each other. This can suppress reduction in detection accuracy of the rotation position by the rotation position detector, and can prevent increase in axial dimension of the rotating electrical machine.

Thus, by disposing the rotation position detector on the one axial end side of the stator core, the axial dimension of the rotating electrical machine can be maintained at a small value while accurately detecting the rotation position of the rotor.

### BRIEF DESCRIPTION OF THE DRAWINGS

FIG. 1 is a cross-sectional illustration showing a rotating electrical machine according to an embodiment;

FIG. 2 is a cross-sectional illustration showing the rotating electrical machine disposed in a housing according to the embodiment;

FIG. 3 is a perspective view showing a stator according to the embodiment;

FIG. 4 is a cross-sectional illustration showing the stator as viewed from an axial direction according to the embodiment;

FIG. 5 is a perspective view showing a U-phase coil according to the embodiment; and

FIG. 6 is a perspective view showing a coil assembly formed by combining U-phase, V-phase, and W-phase coils according to the embodiment.

### DETAILED DESCRIPTION OF THE EMBODIMENT

A preferred embodiment of the present invention described above will be described below.

In the present invention, the rotating electrical machine can be used as a motor, a generator, and a motor-generator.

Moreover, the coils of the plurality of phases can be formed by using rectangular conductors having a substantially quadrangular cross section, rectangular conductors having a flat cross section, and the like. Moreover, the coils of the plurality of phases can be formed by rectangular conductors that are produced by forming an insulating coating, made of an insulating resin or the like, on the entire periphery of a conductor portion made of copper or the like.

Moreover, it is preferable that the rotation position detector be disposed on an inner peripheral side of the one end-side coil end portion so as to axially overlap the one end-side coil end portion.

In this case, the rotation position detector can be disposed inside the space located on the inner peripheral side of the one end-side coil end portion, whereby the axial dimension of the rotating electrical machine can further be reduced.

Moreover, it is preferable that the rotation position detector be a resolver that is formed by a resolver rotor connected to the rotor, and a resolver stator disposed so as to face an outer peripheral side of the resolver rotor.

In this case, the resolver as the rotation position detector can be easily disposed while maintaining the reduced size of the rotating electrical machine.

### Embodiment

An embodiment of a rotating electrical machine of the present invention will be described below in detail with reference to the accompanying drawings.

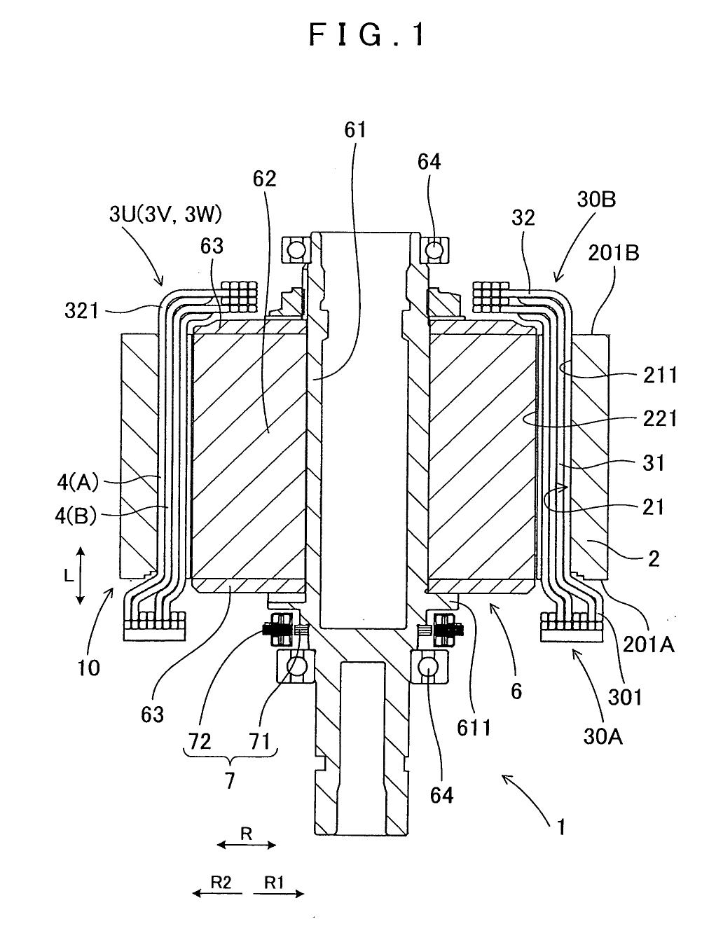

As shown in FIG. 1, a rotating electrical machine 1 of this embodiment includes a stator 10, which is formed by disposing three-phase coils 3U, 3V, and 3W in a distributed winding state in a plurality of slots 21 formed along an axial direction of a stator core 2, and a rotor 6 rotatably provided on the inner peripheral side of the stator 10.

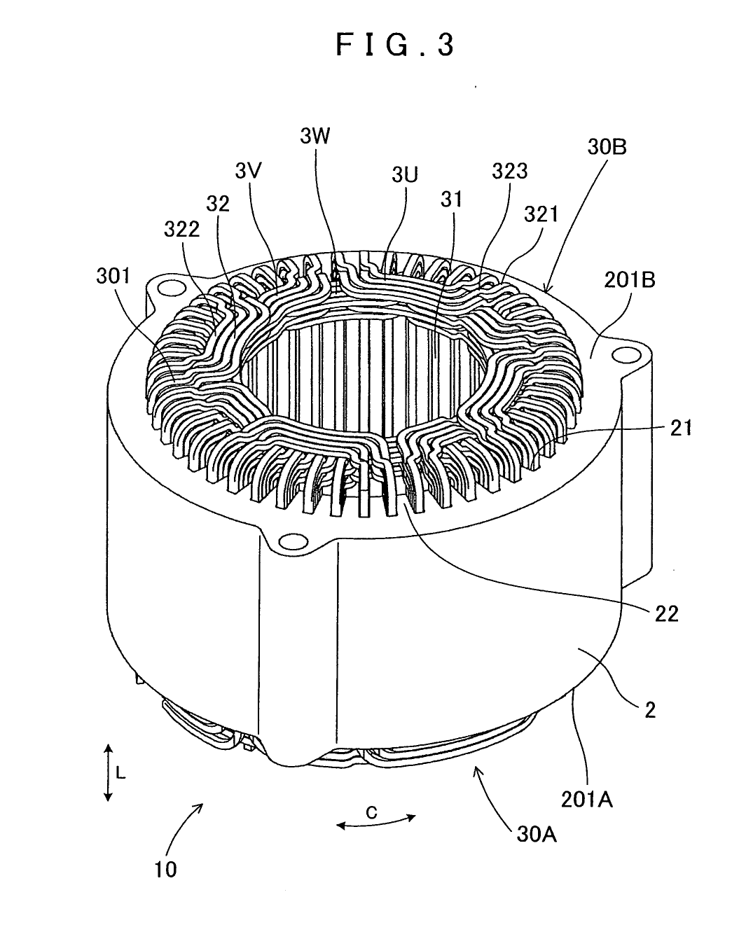

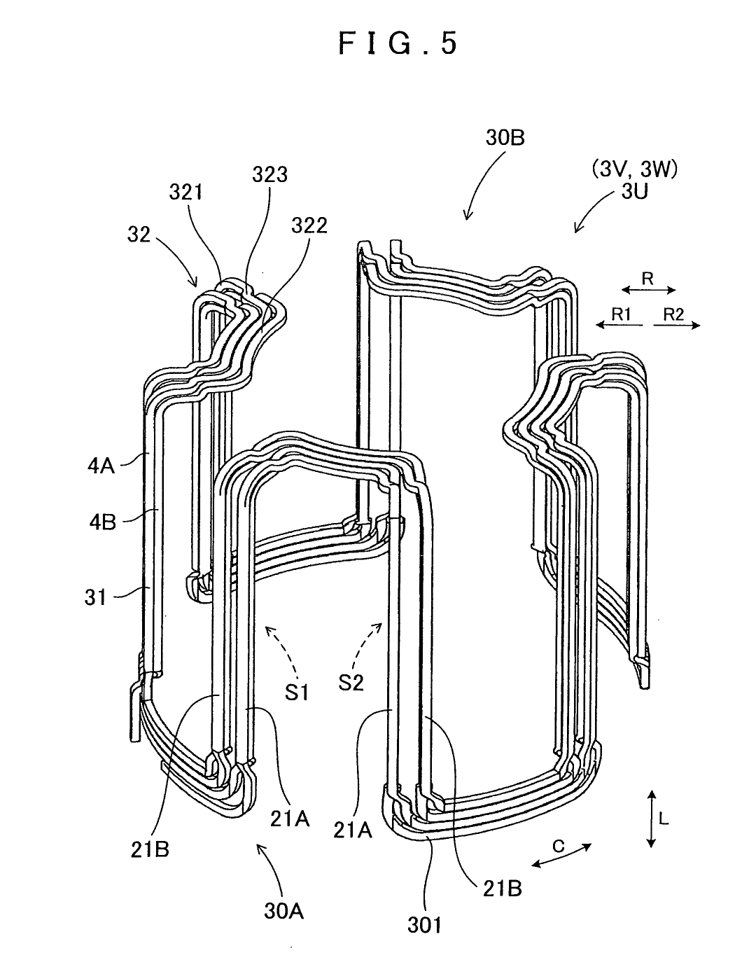

As shown in FIGS. 3 and 5, the three-phase coils 3U, 3W, and 3W are disposed so that: in the slots 21 of the same phase, a plurality of coil conductors 4 of the same phase are arranged adjacent to each other in a radial direction R of the stator core 2; in one end-side coil end portion 30A that protrudes from one axial end face 201A of the stator core 2, the plurality of coil conductors 4 of the same phase are arranged on a radially outer peripheral side R2 of an inner peripheral end face 221 of the stator core 2; and in the other end-side coil end portion 30B that protrudes from the other axial end face 201B of the stator core 2, the plurality of coil conductors 4 of the same phase are bent toward the inner periphery in the radial direction R of the stator core 2, and are arranged on a radially inner peripheral side R1 of the inner peripheral end face 221 of the stator core 2. Moreover, a rotation position detector 7 for detecting the rotation position of the rotor 6 is disposed on one axial end side of the stator core 2.

The rotating electrical machine 1 of the present embodiment will be described below with reference to FIGS. 1 through 6.

As shown in FIG. 1, the rotating electrical machine 1 of the present embodiment is used as a three-phase alternating current (AC) motor for hybrid cars, electric cars, and the like, and has the stator 10 in which the three-phase coils 3U, 3V, and 3W of U-phase, V-phase, and W-phase are assembled to the stator core 2.

Moreover, the three-phase coils 3U, 3V, and 3W are structured by using rectangular conductors 301 which are produced by forming an insulating coating, such as an insulating resin, on the entire periphery of a conductor portion (a conductor base material) made of copper or the like. The rectangular conductors 301 have a substantially quadrangular cross section.

As shown in FIG. 5, the three-phase coils 3U, 3V, and 3W of the present embodiment are formed in a wave winding shape in which the coils extend from within the slots 21 alternately to the one end-side coil end portion 30A and the other end-side coil end portion 30B so as to be wound around a circumferential direction C of the stator core 2. Moreover, the three-phase coils 3U, 3V, and 3W of the present embodiment are formed in a wave winding shape by using two coil conductors 4 disposed in the same slot 21 as a set. Moreover, the two coil conductors 4 are formed by winding one continuous rectangular conductor 301 around the circumferential direction C of the stator core 2 twice.

As shown in FIGS. 3 and 5, the coil 3U, 3V, 3W of each phase is formed by slot conductor portions 31 disposed in the slots 21, and coil end conductor portions 32 disposed so as to protrude from axial end faces 201 of the stator core 2 (i.e., disposed outside the slots 21). Each coil end conductor portion 32 located in the one end-side coil end portion 30A is formed by bent corner conductor portions 321, which are connected to the slot conductor portions 31, stand up from the one axial end face 201A of the stator core 2, and are bent in the circumferential direction C, and circumferential conductor portions 322, which connect the bent corner conductor portions 321 respectively connected to the slot conductor portions 31, and are arranged in the circumferential direction C of the stator core 2. Each coil end conductor portion 32 located in the other end-side coil end portion 30B is formed by bent corner conductor portions 321, which are connected to the slot conductor portions 31, stand up from the other axial end face 201B of the stator core 2, and are bent to the radially inner peripheral side R1, and circumferential conductor portions 322, which connect the bent corner conductor portions 321 respectively connected to the slot conductor portions 31, and are arranged in the circumferential direction C of the stator core 2.

The circumferential conductor portions 322 are formed in a circular arc shape along the circumferential direction C of the stator core 2 in the one end-side coil end portion 30A and the other end-side coil end portion 30B. Moreover, the circumferential conductor portions 322 may be formed in a linear shape in the other end-side coil end portion 30B.

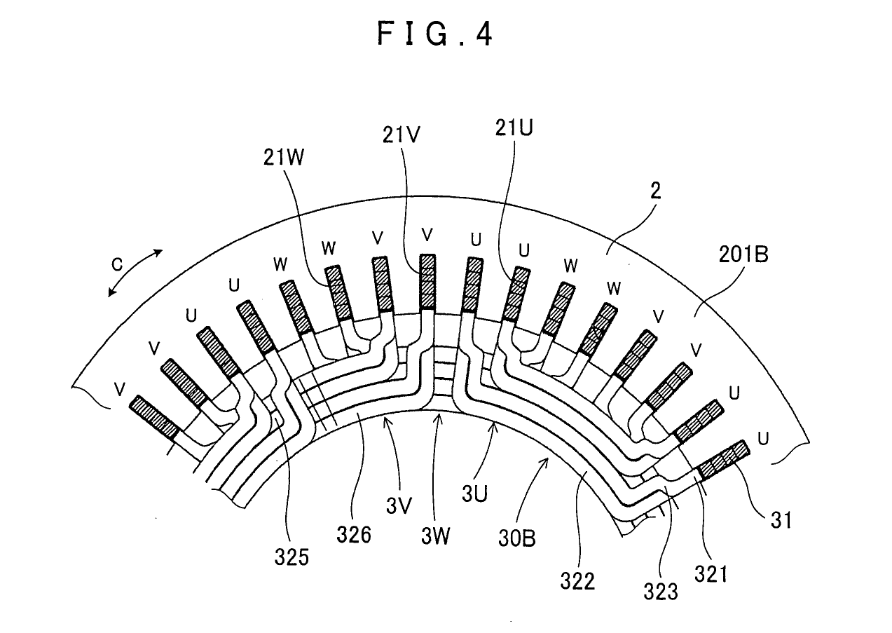

As shown in FIGS. 3 and 4, in the one end-side coil end portion 30A, the circumferential conductor portions 322 of each phase have a portion where the U-phase circumferential conductor portions 322 and the V-phase circumferential conductor portions 322 are arranged so as to overlap each other in the radial direction R of the stator core 2, a portion where the U-phase circumferential conductor portions 322 and the W-phase circumferential conductor portions 322 are arranged so as to overlap each other in the radial direction R of the stator core 2, and a portion where the V-phase circumferential conductor portions 322 and the W-phase circumferential conductor portions 322 are arranged so as to overlap each other in the radial direction R of the stator core 2.

As shown in FIG. 4, two adjacent U-phase slots 21U, two adjacent V-phase slots 21V, and two adjacent W-phase slots 21W are sequentially repeatedly formed in the stator core 2. In the stator core 2 of the present embodiment, two adjacent slots 21 of each phase are formed at eight locations in the circumferential direction C of the stator core 2. Thus, sixteen slots 21 are formed for each phase, and a total of forty eight slots 21 are formed for the three phases.

The three-phase coils 3U, 3V, and 3W of the present embodiment use sets of two coil conductors 4 which are arranged adjacent to each other in the radial direction R in the same slot 21, where every two sets of two coil conductors 4 are arranged adjacent to each other in the same slot 21 in the radial direction R of the stator core 2. Thus, in each slot 21, the four coil conductors 4 of the same phase are arranged adjacent to each other in the radial direction R. Similarly, four coil conductors 4 are arranged adjacent to each other in the radial direction R in each of the slots 21 of the same phase which are adjacent to each other.

As shown in FIG. 5, a set of two coil conductors 4, which are located on the inner side in an axial direction L of the stator core 2 in the one end-side coil end portion 30A, are located on the radially inner peripheral side R1 of the stator core 2 in the other end-side coil end portion 30B. On the other hand, a set of two coil conductors 4, which are located on the outer side in the axial direction L of the stator core 2 in the one end-side coil end portion 30A, are located on the radially outer peripheral side R2 of the stator core 2 in the other end-side coil end portion 30B.

In the three-phase coils 3U, 3V, and 3W, sets of two coil conductors 4 of the same phase are arranged adjacent to each other in the radial direction R of the stator core 2 in each of adjacent slots 21 of the same phase. Moreover, in each of adjacent slots 21 of the same phase, another set of two coil conductors 4 of the same phase are arranged adjacent to each other on the radially inner peripheral side R1 of a set of two coil conductors 4 of the same phase.

Moreover, in the one end-side coil end portion 30A in the three-phase coils 3U, 3V, and 3W, sets of two coil conductors 4 of the same phase, which are disposed in each slot 21 of the same phase, are arranged adjacent to each other in the axial direction L of the stator core 2. Moreover, sets of two coil conductors 4 of the same phase, which are disposed in adjacent slots 21 of the same phase, are arranged in four lines in the axial direction L of the stator core 2.

Note that the sets of two coil conductors 4 of the same phase, which are disposed in adjacent slots 21 of the same phase, may be formed integrally by winding one continuous rectangular conductor 301 around the circumferential direction C of the stator core 2 four times.

Moreover, as shown in FIGS. 4 and 5, in the other end-side coil end portion 30B in the three-phase coils 3U, 3V, and 3W, two coil conductors 4 of the same phase, which are disposed in one of adjacent slots 21 of the same phase, and two coil conductors 4 of the same phase, which are disposed in the other of the adjacent slots 21 of the same phase, are arranged in four lines in the radial direction R of the stator core 2.

Moreover, in the other end-side coil end portion 30B, of two coil conductors 4 of the same phase which are disposed adjacent to each other in the radial direction R of the stator core 2 in each slot 21 of the same phase, one coil conductor 4A is bent toward the radially inner peripheral side R1 of the stator core 2 in a state perpendicular to the axial direction L of the stator core 2. The other coil conductor 4B is bent toward the radially inner peripheral side R1 of the stator core 2, and is offset with respect to the axial direction L of the stator core 2 so that the other coil conductor 4B is arranged adjacent to the one coil conductor 4A in the radial direction R of the stator core 2.

As shown in FIG. 5, in the other end-side coil end portion 30B of the present embodiment, any two adjacent slots 21 of the same phase as viewed from one end side in the axial direction L of the stator core 2 are referred to as a first slot set S1, and two adjacent slots 21 of the same phase, which are located on one side of the two slots 21 of the same phase of the first slot set S1 in the circumferential direction C, are referred to as a second slot set S2. Moreover, in the range where the first slot set S1 and the second slot set S2 are arranged adjacent to each other in the circumferential direction C, the slots 21 located on the inner side in the circumferential direction C are referred to as inner slots 21A, and the slots 21 located on the outer side in the circumferential direction C are referred to as outer slots 21B.

In each radial conductor portion 323 between the bent corner conductor portion 321 and the circumferential conductor portion 322, arrangement of the coil conductors 4 changes from the state where the two coil conductors 4 are arranged adjacent to each other in the axial direction L of the stator core 2 in the bent corner conductor portion 321, to the state where the two coil conductors 4 are arranged adjacent to each other in the radial direction R.

The coil conductors 4 of the three-phase coils 3U, 3V, and 3W are arranged so as to extend from two adjacent slots 21 of the same phase (the first slot set S1) to two slots 21 of the same phase which are adjacent to the two slots 21 of the same phase in the circumferential direction C (the second slot set S2).

As shown in FIG. 4, in the other end-side coil end portion 30B, each coil conductor 4 in the V-phase coil 3V is offset in the axial direction L of the stator core 2 in a central portion in the circumferential direction C of the stator core 2, and has an inner portion 325, which is located on one side C1 in the circumferential direction of the stator core 2 and on the inner side in the axial direction thereof, and an outer portion 326, which is located on the other side C2 in the circumferential direction of the stator core 2 and on the outer side in the axial direction thereof. Moreover, each coil conductor 4 in the U-phase coil 3U is disposed so as to overlap the inner portion 325 of each coil conductor 4 in the V-phase coil 3V in an axially outward direction of the stator core 2. Each coil conductor 4 in the W-phase coil 3W is disposed so as to overlap the outer portion 326 of each coil conductor 4 in the V-phase coil 3V in an axially inward direction of the stator core 2.

Moreover, as shown in FIG. 5, in the other end-side coil end portion 30B, the sets of two coil conductors 4 of the coil 3U, 3V, 3W of each phase, which are disposed outside in the radial direction R in the slots 21 of each phase (the outer slots 21B), are distributed substantially uniformly in the circumferential direction C in the range of the width in the axial direction L corresponding to two phases. Moreover, in the other end-side coil end portion 30B, the sets of two coil conductors 4 of the coil 3U, 3V, 3W of each phase, which are disposed inside in the radial direction R in the slots 21 of each phase (the inner slots 21A), are distributed substantially uniformly in the circumferential direction C in the range of the width in the axial direction L corresponding to two phases, in an overlapping state with the sets of two coil conductors 4 disposed outside in the radial direction R, on the inner side in the axial direction L.

Before assembly in the stator core 2, in the three-phase coils 3U, 3V, and 3W of the present embodiment, similar to the one end-side coil end portion 30A, the coil conductors 4 are formed in parallel to the axial direction L, shaped in a wave winding shape around the circumferential direction C, and then, bent to the inner peripheral side of the radial direction R so as to form the other end-side coil end portion 30B.

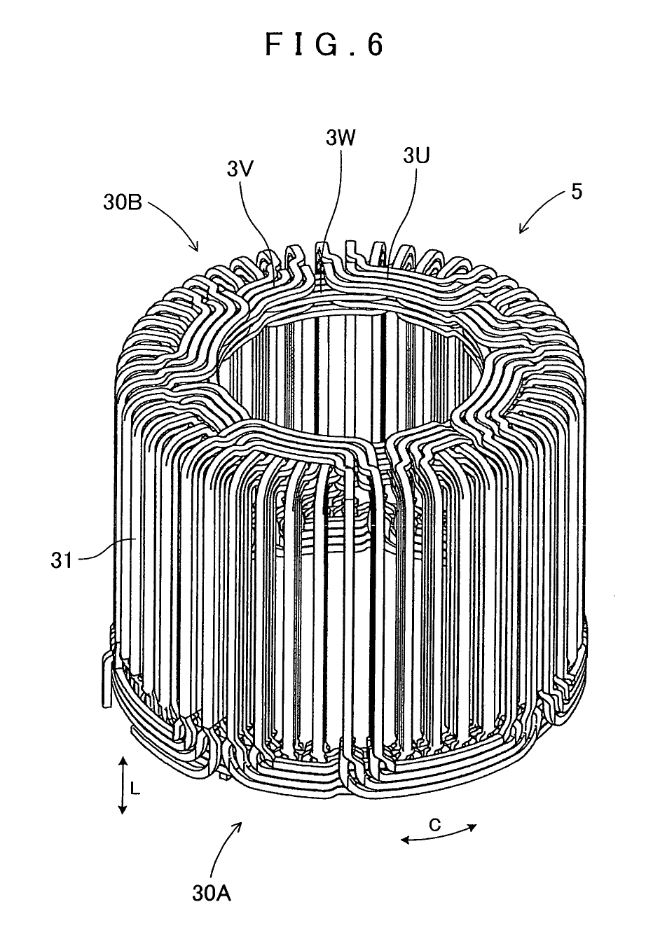

Moreover, as shown in FIG. 6, the three-phase coils 3U, 3V, and 3W of the present embodiment are formed as a coil assembly 5 by combining all of the coils to be disposed in the stator core 2, and the coil assembly 5 is collectively disposed in the stator core 2. Note that, although not shown in the drawing, assembling jigs for positioning the three-phase coils 3U, 3V, and 3W may be used to form the coil assembly 5. Moreover, insertion jigs may be used to dispose the coil assembly 5 in the stator core 2, whereby insertion and disposition of the coil assembly 5 can be facilitated.

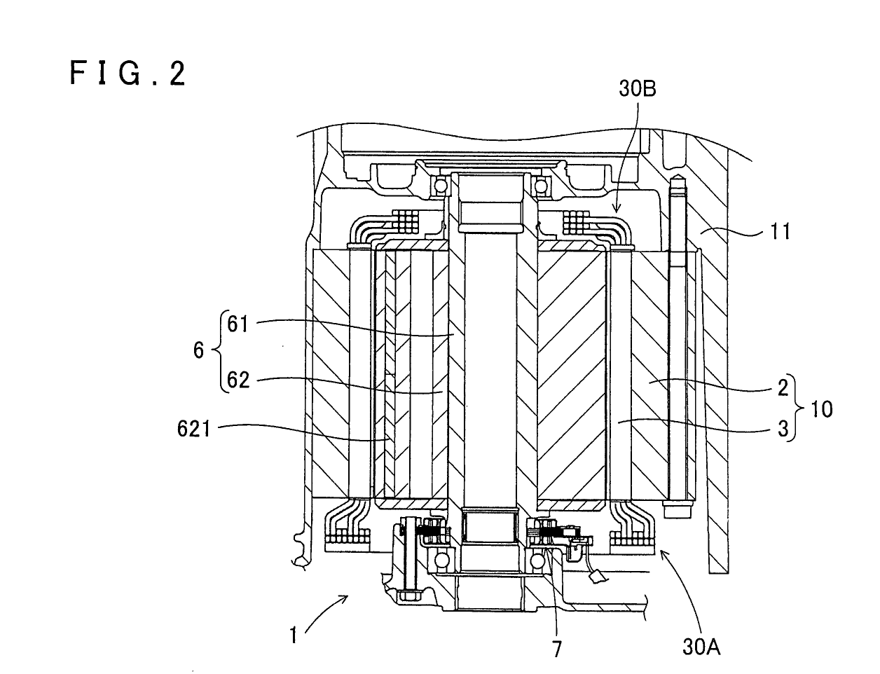

As shown in FIGS. 1 and 2, the rotor 6 of the present embodiment is formed by disposing a rotor core 62, having a plurality of permanent magnets 621 arranged in a circumferential direction, on the outer peripheral side of a rotor shaft 61. The rotation position detector 7 is positioned on the inner peripheral side of the one end-side coil end portion 30A so as to overlap the one end-side coil end portion 30A in the axial direction L. That is, the rotation position detector 7 is positioned so that at least a part of the rotation position detector 7 faces a position on the inner peripheral side of the one end-side coil end portion 30A.

As shown in FIGS. 1 and 2, the rotation position detector 7 of the present embodiment is a resolver (two-phase synchronous), which is formed by a resolver rotor 71 disposed on the outer peripheral side of the rotor shaft 61, and a resolver stator 72 disposed so as to face the outer peripheral side of the resolver rotor 71. Resolver coils are respectively wound up on the resolver rotor 71 and the resolver stator 72 so that the respective winding directions are perpendicular to each other. With an AC voltage being applied to the resolver coil of the resolver stator 72, the rotation position detector 7 detects the rotation position of the rotor 6 based on that the phase of the AC voltage that is output from the resolver coil of the resolver rotor 71 changes with rotation of the rotor 6. The rotation position detector 7 detects the rotation positions in the circumferential direction C of the plurality of permanent magnets 621 in the rotor 6 with respect to the positions in the circumferential direction C at which the three-phase coils 3U, 3V, and 3W are disposed, whereby the timing of applying a voltage to the three-phase coils 3U, 3V, and 3W can be controlled.

The stator core 2 and the rotor core 62 are formed by stacking a multiplicity of electromagnetic steel plates in the axial direction. Moreover, end plates 63 for maintaining the stacked state of the multiplicity of electromagnetic steel plates are provided on both axial end faces of the rotor core 62. An outer peripheral portion in the circumferential direction of the end plate 63 located on the other axial end side has a cut-out shape for preventing interference with the coil conductors 4 of the other end-side coil end portion 30B.

Moreover, as shown in FIGS. 1 and 2, the stator 10 and the rotor 6 are disposed in a housing 11 of the rotating electrical machine 1, and the resolver stator 72 is fixed to the housing 11. In the rotor shaft 61, bearings 64 for supporting rotation of the rotor 6 are provided at outer positions on both axial sides of the position at which the rotor core 62 is disposed. The rotor 6 is formed by holding the rotor core 62 between a flange portion 611 and a fastening nut 612 with the pair of end plates 63 interposed therebetween, where the flange portion 611 protrudes to the radially outer peripheral side of the rotor shaft 61. Moreover, the rotation position detector 7 is disposed at a position between the flange portion 611 and the bearing 64.

Advantageous effects of the rotating electrical machine 1 of the present embodiment will next be described.

The rotating electrical machine 1 of the present embodiment facilitates disposition of the three-phase coils 3U, 3V, and 3W in the stator core 2 by devising the shape of the other end-side coil end portion 30B, and also, eliminates the need to further form the three-phase coils 3U, 3V, and 3W after disposed in the stator coil 2.

More specifically, in the stator 10 of the present embodiment, the one end-side coil end portion 30A is bent to the radially outer peripheral side R2 of the stator core 2 in advance before disposed in the stator core 2, as in the related art. Thus, the one end-side coil end portion 30A can be shaped so as to be entirely located on the radially outer peripheral side R2 of the inner peripheral end face 221 in teeth 22 (portions located between the slots 21). Note that the coil end conductor portions 32 located in the one end-side coil end portion 30A can be formed so as to be bent toward the radially outer peripheral side R2. Thus, as shown in FIG. 1, when the rotor 6 is inserted and disposed in the stator 10 formed by disposing the three-phase coils 3U, 3V, and 3W in the stator core 2, the rotor 6 can be inserted and disposed from the one axial end face 201A side of the stator core 2 where the one end-side coil end portion 30A is located. Thus, the rotor 6 can be easily disposed in the stator 10.

Moreover, the other end-side coil end portion 30B is bent to the radially inner peripheral side R1 of the stator core 2 in advance before disposed in the stator core 2. Thus, the other end-side coil end portion 30B is shaped so as to be entirely located on the radially inner peripheral side R1 of an outer peripheral end face 211 in the slots 21. Therefore, as shown in FIG. 1, when the three-phase coils 3U, 3V, and 3W are inserted and disposed in the stator core 2, the three-phase coils 3U, 3V, and 3W can be inserted and disposed into the one axial end face 201A side of the stator core 2, from the side of the three-phase coils 3U, 3V, and 3W which forms the other end-side coil end portion 30B. Thus, the three-phase coils 3U, 3V, and 3W can be easily disposed in the stator core 2.

Moreover, in the three-phase coils 3U, 3V, and 3W, a plurality of coil conductors 4 of the same phase are arranged adjacent to each other in the radial direction R of the stator core 2, in the other end-side coil end portion 30B. Thus, the amount by which the other end-side coil end portion 30B protrudes from the other axial end face 201B of the stator core 2 can be reduced on the other end side in the axial direction L of the stator 10.

Thus, the coil end portion 30B located on the other axial end face 201B side in the stator 10 can be reduced in size in the axial direction L.

Moreover, in the stator 10 of the present embodiment, the one end-side coil end portion 30A and the other end-side coil end portion 30B can be formed in an assembled shape in advance before disposed in the stator core 2. Both coil end potions 30A and 30B after assembled in the stator core 2 can be used as a product almost in the shape as they are disposed in the stator core 2, without performing any forming processes such as a bending forming process and a compression forming process. Thus, the insulating coatings formed on the surfaces of the coil conductors 4 of coils 3 are hardly destroyed or degraded. Therefore, quality of the stator can be improved according to the stator 10 of the present embodiment.

Moreover, as shown in FIG. 6, in the stator 10 of the present embodiment, especially the three-phase coils 3U, 3V, and 3W are assembled in advance before inserted and disposed in the stator core 2, so that all of the three-phase coils 3U, 3V, and 3W can be simultaneously inserted and disposed in the stator core 2. Thus, the three-phase coils 3U, 3V, and 3W can be very easily inserted and disposed in the stator core 2. Note that the insertion and disposition of the coils 3 in the stator core 2 may be performed by a predetermined unit (a predetermined number) at a time, and the coils disposed in the stator core 2 can be bonded by welding or the like.

Moreover, in the rotor 6 in the rotating electrical machine 1 of the present embodiment, the rotation position detector 7 for detecting the rotation position of the rotor 6 is disposed on the rotor shaft 61 at a position on the inner peripheral side of the one end-side coil end portion 30A, as described above.

In the case where the rotation position detector 7 is disposed on the other axial end side of the rotor shaft 61, the other end-side coil end portion 30B and the rotation position detector 7 are located close to each other. Thus, noise is superimposed on the rotation position detector 7, thereby reducing the detection accuracy. In this case, if the rotation position detector 7 is disposed so as to avoid interference with the other end-side coil end portion 30B, the axial dimension of the rotating electrical machine 1 is increased.

On the other hand, by disposing the rotation position detector 7 on the one axial end side of the rotor shaft 61, the one end-side coil end portion 30A and the rotation position detector 7 can be disposed away from each other. This can suppress reduction in detection accuracy of the rotation position by the rotation position detector 7, and can prevent increase in axial dimension of the rotating electrical machine 1.

Thus, by disposing the rotation position detector 7 on the one axial end side of the stator core 2, the axial dimension of the rotating electrical machine 1 can be maintained at a small value while accurately detecting the rotation position of the rotor 6.

Thus, according to the present embodiment, the three-phase coils 3U, 3V, and 3W can be easily disposed in the stator core 2, high quality of the three-phase coils 3U, 3V, and 3W can be maintained, and the size of the rotating electrical machine 1 can be reduced while accurately detecting the rotation position of the rotor 6.

What is claimed is:

1. A rotating electrical machine, comprising:
a stator formed by disposing coils of a plurality of phases in a plurality of slots formed along an axial direction of a stator core; and
a rotor rotatably provided on an inner peripheral side of the stator, wherein
the coils of the plurality of phases are disposed so that
in the slots of the same phase, a plurality of coil conductors of the same phase are arranged adjacent to each other in a radial direction of the stator core,
in one end-side coil end portion that protrudes from one axial end face of the stator core, the plurality of coil conductors of the same phase are arranged on a radially outer peripheral side of an inner peripheral end face of the stator core, and
in the other end-side coil end portion that protrudes from the other axial end face of the stator core, the plurality of coil conductors of the same phase are arranged on a radially inner peripheral side of the inner peripheral end face of the stator core, and
a rotation position detector for detecting a rotation position of the rotor is disposed on the one axial end side of the stator core.

2. The rotating electrical machine according to claim 1, wherein
the rotation position detector is disposed on an inner peripheral side of the one end-side coil end portion so as to axially overlap the one end-side coil end portion.

3. The rotating electrical machine according to claim 2, wherein
the rotation position detector is a resolver that is formed by a resolver rotor connected to the rotor, and a resolver stator disposed so as to face an outer peripheral side of the resolver rotor.

4. The rotating electrical machine according to claim 1, wherein
the rotation position detector is a resolver that is formed by a resolver rotor connected to the rotor, and a resolver stator disposed so as to face an outer peripheral side of the resolver rotor.
